(19) United States
(12) Patent Application Publication
(10) Pub. No.: US 2024/0217765 A1
(43) Pub. Date: Jul. 4, 2024

(54) CARD MAKING ALIGNMENT DEVICE

(71) Applicants: Melissa Ketcherside, St. Louis, MO (US); Justin Vitale, St. Louis, MO (US)

(72) Inventors: Melissa Ketcherside, St. Louis, MO (US); Justin Vitale, St. Louis, MO (US)

(21) Appl. No.: 18/092,938

(22) Filed: Jan. 4, 2023

(51) Int. Cl. B65H 9/00

(52) U.S. Cl. CPC B65H 9/00

(57) ABSTRACT

An improved card making alignment device for ease and accuracy in creating cards from card stock. The device has a base, the base having a center, a first side, a second side, a third side and a fourth side. The device has two first finger holes, two A2 middle paper guides, a first rectangular opening of a first of the A2 middle paper guides, a second rectangular opening of a first of the A2 middle paper guides, a first top mounted finger hole, a second top mounted finger hole, a first inner exterior layer, a second inner exterior layer, a first raised border and a second raised border providing a guidance of the card stock.

### FIELD OF THE INVENTION

This invention relates to card production. More particularly, it relates to an improved card making alignment device.

### BACKGROUND

A greeting card is a piece of card stock, usually with an illustration or photo, made of high-quality paper featuring an expression of friendship or other sentiment. Although greeting cards are usually given on special occasions such as birthdays, Christmas or other holidays, such as Halloween, they are also sent to convey thanks or express other feelings (such as condolences or best wishes to get well from illness).

Greeting cards are usually packaged with an envelope and come in a variety of styles. There are both mass-produced and handmade versions available and they may be distributed by hundreds of companies large and small. While typically inexpensive, more elaborate cards with die-cuts, pop-ups, sound elements or glued-on decorations may be more expensive.

There are several different types of cards, including, but not limited to:

Counter cards: Greeting cards that are sold individually. This contrasts with boxed cards.

Standard: A standard greeting card is printed on high-quality paper (such as card stock), and is rectangular and folded, with a picture or decorative motif on the front. Inside is a pre-printed message appropriate for the occasion, along with a blank space for the sender to add a signature or handwritten message. A matching envelope is sold with the card. Some cards and envelopes feature fancy materials, such as gold leaf, ribbons, or glitter.

Handmade: A Handmade card is a card which includes a production stage or a feature that is made by hand. The term covers a wide range of products including not only for example, applique items or ribbons but also pop-up and 3-D cards as well as cards made with mixed materials. The term “Handmade” is applied both to cards made by amateurs and to volume-production cards that include stages made by hand.

Photo: A photo card is a card which features a photograph chosen by the sender. There are two main types of photo card. The first is the photo insert card which is designed to display a sender's own photo. Depending on the card design, the photo is stuck to the card, clipped to the card or slid into a pocket in the card into which a hole has been cut to act as a frame. The second type is the printed photo card, in which the photo is combined with artwork and printed directly onto the face of the card. Both types are popular for sending holiday greetings such as Christmas, Hanukkah, and for baby showers, where the sender wishes to send a memento of their own family.

Personalized: A personalized card is a card which is personalized with the sender's own pictures or a personal audible message. Websites using special print-personalization technology, such as Moonpig, allow consumers to personalize a card which is then printed and sent directly to the recipient. Sound personalization is also possible using a small recording device called a Botski, which is a sticker-based recordable medium allowing users to record songs, sounds or spoken words and include them in a greeting card.

Reusable: These are greeting cards for the budget conscious. There are two common formats for reusable cards. Firstly, there are cards with slits in them positioned to hold pages. Secondly, there are notepad style cards where pages stick to the back of the cards. The pages that have been used for reusable cards can be removed after being received and fresh pages can be used to reuse the cards.

Sound-based or Musical: Some greeting cards play music or other sound when they are opened. They are commonly 3D handmade cards which play traditional celebration songs such as “Happy Birthday to You.” They also may be personalized using a Botski which is a small, sticker-based recordable medium which users can record their own music, sounds or voice greeting and apply it to a card.

Electronic: (also called e-cards) Greeting cards can also be sent electronically. Flash-based cards can be sent by email, and many sites such as Facebook enable users to send greetings. More recently, services have launched which enable users to send greetings to a mobile phone by text message or use mobile app for this purpose such cards are called Mobile E-cards or MCards. Many of these electronic services offer open or anonymous chat, to enable further discussion.

Quilling Cards: Quilling cards are greeting cards that contain a Quilled design on the front of the card. Quilling is an artform where strips of paper are rolled to make intricate designs. These cards are unique and handcrafted and are often framed as works of art.

Printable: Also known as digital greeting cards, they can be found online through shopping platforms such as Etsy and some blogs. Usually available in the form of a PDF document, the design for a card can be printed out at home or a local print shop. Printable cards have allowed designers to make cards readily available to customers all over the world.

Get Well: A get-well card is a greeting card which is sent to someone when they are ill. Their use in the case of chronic and terminal illness is problematic because the patient may not be expected to recover but they may still offer comfort to the invalid.

Fabric. The concept of a khaki fabric card appeared in 1899 during the first Christmas of the Boer War and was issued by a business in Glasgow. In New Zealand, it was not uncommon to receive a khaki greeting card, even the premier, RJ Seddon is said to have received one. An example of a fabric card is held by the Auckland War Memorial Museum, and is a small square of fabric with a heavy fringe created by threads with a hand written greeting.

One of the problems when producing cards, whether the card is a greeting card or some other type of card, is that card stock comes in various types of material and various sizes and shapes. Currently, card printing machines do not accommodate for the various sizes and shapes, this can cause the card stock to be torn, moved to an angle, jam the machine, etc.

Accordingly, and in light of the foregoing, there is a need for a device that can properly align the card stock while in the printing facet of the card making process. The device should be easy to use, cost-efficient and reusable.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a front view of the base 15, as used with the card making alignment device 10, according to the preferred embodiment of the present invention;

FIG. 2 is a front view of the A2 middle paper guide 25, as used with the card making alignment device 10, according to the preferred embodiment of the present invention;

FIG. 3 is a front view of the first inner exterior layer 45, as used with the card making alignment device 10, according to the preferred embodiment of the present invention;

FIG. 4 is a front view of the second inner exterior layer 65, as used with the card making alignment device 10, according to the preferred embodiment of the present invention;

FIG. 5 is a front view of the first raised border 80 as used with the card making alignment device 10, according to the preferred embodiment of the present invention;

FIG. 6 is a front view of the second raided border 95, as used with the card making alignment device 10, according to the preferred embodiment of the present invention;

FIG. 7 is an exploded side view of the card making alignment device 10, according to the preferred embodiment of the present invention;

FIG. 8a is a top view of the card making alignment device 10, according to the preferred embodiment of the present invention; and,

FIG. 8b is a bottom view of the card making alignment device 10, according to the preferred embodiment of the present invention.

### DESCRIPTIVE KEY

10 card making alignment device
15 base
20 first finger hole
25 A2 middle paper guide
30 first rectangular opening
35 first side edge
40 second finger hole
45 first inner exterior layer
50 second rectangular opening
55 second side leg
60 chamfer
65 second inner exterior layer
70 third rectangular opening
75 third side leg
80 first raised border
85 first side
90 fourth side leg
95 second raised border
100 second sides
105 fifth side leg

### DESCRIPTION OF THE PREFERRED EMBODIMENTS

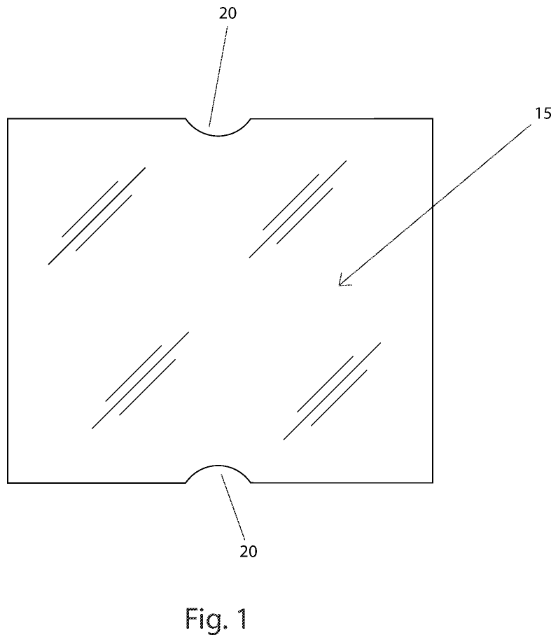

The best mode for carrying out the invention is presented in terms of its preferred embodiment, herein depicted within FIGS. 1 through 8b. However, the invention is not limited to the described embodiment, and a person skilled in the art will appreciate that many other embodiments of the invention are possible without deviating from the basic concept of the invention and that any such work around will also fall under scope of this invention. It is envisioned that other styles and configurations of the present invention can be easily incorporated into the teachings of the present invention, and only one (1) particular configuration shall be shown and described for purposes of clarity and disclosure and not by way of limitation of scope. All of the implementations described below are exemplary implementations provided to enable persons skilled in the art to make or use the embodiments of the disclosure and are not intended to limit the scope of the disclosure, which is defined by the claims.

The terms “a” and “an” herein do not denote a limitation of quantity, but rather denote the presence of at least one (1) of the referenced items.

### 1. DETAILED DESCRIPTION OF THE FIGURES

Referring now to FIG. 1, a front view of the base 15, as used with the card making alignment device 10, according to the preferred embodiment of the present invention is disclosed. The card making alignment device (herein also described as the “device”) 10, provides for a paper border guide for one-quarter of an inch (¼ in.) or one-eighth of an inch (⅛ in.) borders for card making. The base 15 provides a central foundation for other components of the present invention. The base 15 is approximately seven inches (7 in.) wide and six inches (6 in.) tall and a thickness of one-eighth of an inch (⅛ in.). The base 15 is the thickest of all following layer and is provided with smooth sides to allow for easy sliding of paper card stock in and out. The base 15 is envisioned to be made of glass or Plexiglas™. A total of two (2) first finger holes 20 are located in the center of the seven-inch (7 in.) side and are one inch (1 in.) in diameter with an exposed area in the base 15 of one-quarter of an inch (¼ in.) to facilitate paper card stock insertion and removal and preventing associated damage.

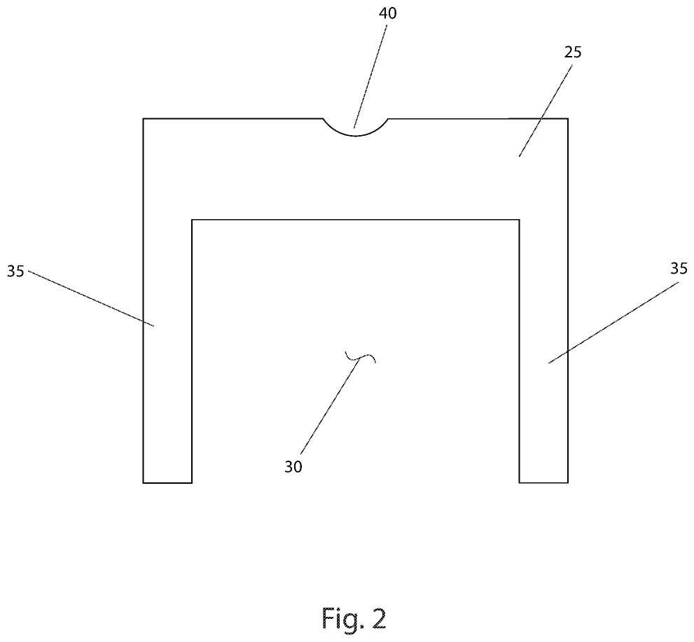

Referring next to FIG. 2, a front view of the A2 middle paper guide 25, as used with the device 10, according to the preferred embodiment of the present invention is depicted. It is noted that a total of two (2) A2 middle paper guide 25 are needed for the card making alignment device 10, while only one (1) A2 middle paper guide 25 is shown in FIG. 2 for purposes of illustration. The A2 middle paper guide 25 is approximately seven inches (7 in.) wide and six inches (6 in.) tall and a thickness of one-sixteenth of a centimeter ( 1/16 cm.). A first rectangular opening 30 is centered in the lower center of the seven-inch (7 in.) side with the approximate dimensions of five and one-half inches (5½ in.) wide and four and one-quarter inches (4¼ in.) tall. This produces two (2) first side edges 35, each with a width of three-quarters of an inch (¾ in.). The first rectangular opening 30 is where the A2 panel of paper card stock is placed for a layer guide (as to be described below) to be placed. A top-mounted second finger hole 40 is provided which is located in the upper center of the seven-inch (7 in.) side and is one inch (1 in.) in diameter with an exposed area in the A2 paper card stock area of one-quarter of an inch (¼ in.) to facilitate paper removal and insertion.

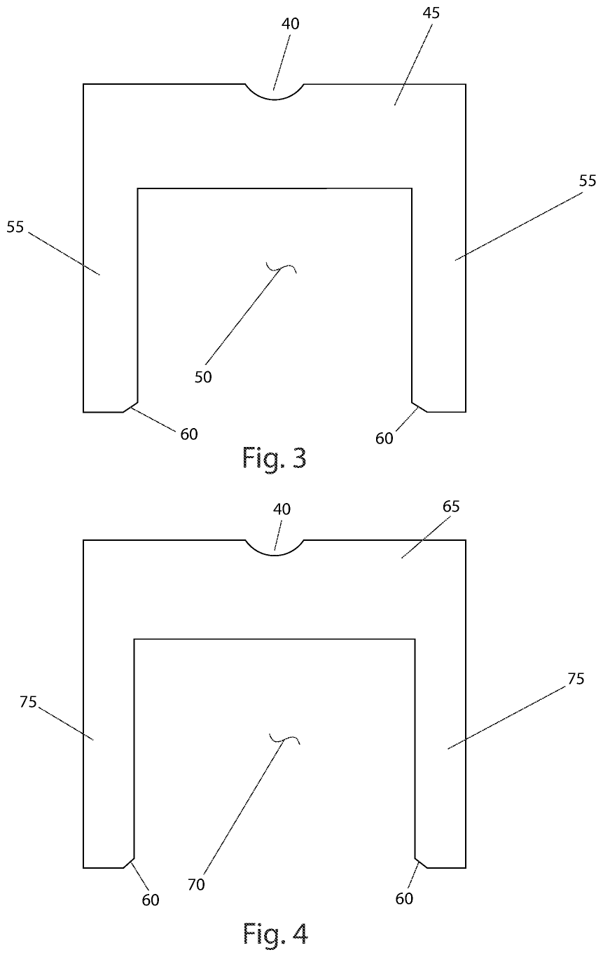

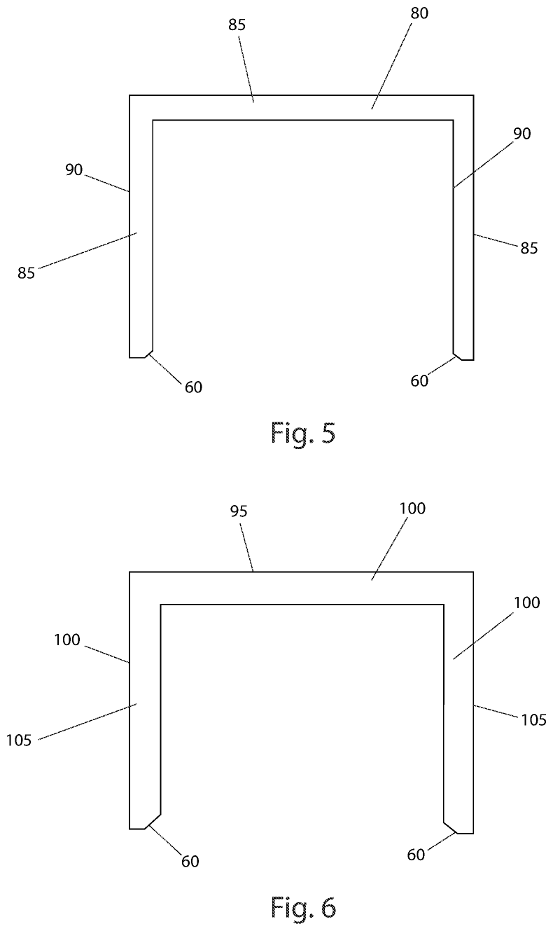

Referring now to FIG. 3, a front view of the first inner exterior layer 45, as used with the device 10, according to the preferred embodiment of the present invention is shown. The first inner exterior layer 45 is approximately seven inches (7 in.) wide and six inches (6 in.) tall and a thickness of one-eighth of an inch (⅛ in.). The first inner exterior layer 45 helps guide in a card stock panel with the dimension of five inches (5 in.) wide and three and three-quarters inches (3¾ in.). This provides for a layered border of one-quarter of an inch (¼ in.). A second rectangular opening 50 is centered in the lower center of the seven-inch (7 in.) side with the approximate dimensions of five inches (5 in.) wide and four inches (4 in.) tall. A top-mounted second finger hole 40 is provided which is located in the upper center of the seven-inch (7 in.) side and is one inch (1 in.) in diameter with an exposed area in the A2 paper guide of one-quarter of an inch (¼ in.) to facilitate paper removal and insertion. This produces two (2) second side legs 55, each with a width of one inch (1 in.) with a chamfer 60 about their interior corners. The first inner exterior layer 45 facilitates usage of raised border layers as shown in FIGS. 5 AND 6 below.

Referring next to FIG. 4, a second inner exterior layer 65, as used with the device 10, according to the preferred embodiment of the present invention is disclosed. The second inner exterior layer 65 is approximately seven inches (7 in.) wide and six inches (6 in.) tall and a thickness of one-eighth of an inch (⅛ in.). The first inner exterior layer 45 helps guide in a card stock panel with the dimension of five and one-quarter inches (5¼ in.) by four and one-eighth inches (4⅛ in.) paper to slide onto an A2 size of paper for cardmaking layer. This provides for a layered border of one-eighth of an inch (⅛ in.). A third rectangular opening 70 is centered in the lower center of the seven-inch (7 in.) side with the approximate dimensions of five and one-quarter inches (5¼ in.) wide and four and one-eighth inches (4⅛ in.) tall. A top-mounted second finger hole 40 is provided which is located in the upper center of the seven-inch (7 in.) side and is one inch (1 in.) in diameter with an exposed area in the A2 paper guide of one-quarter of an inch (¼ in.) to facilitate paper removal and insertion. This produces two (2) third side legs 75, each with a width of seven-eighths of an inch (⅛ in.) with a chamfer 60 about their interior corners. The first inner exterior layer 45 facilitates usage of raised border layers as shown in FIGS. 5 AND 6 below.

Referring now to FIG. 5, a front view of the first raised border 80 as used with the device 10, according to the preferred embodiment of the present invention is depicted. The first raised border 80 provides for production of a card with a one-eighth of an inch (⅛ in.) raised border layer. As such the first raised border 80 is the final layer for one (1) side of the present invention. This layer is of adequate thickness to allow guidance of the smaller paper panel into place with or without foam tape or dimensional foam stickers. The first raised border 80 is approximately six inches (6 in.) wide and four and one-half inches (4½ in.) tall and a thickness of one-eighth of an inch (⅛ in.). The first raised border 80 is generally “U”-shaped in appearance with three (3) first sides 85, each with a width of three-eighths of an inch (⅜ in.). The two (2) fourth side legs 90 are provided with a chamfer 60 about their interior corners.

Referring next to FIG. 6, a front view of the second raised border 95, as used with the device 10, according to the preferred embodiment of the present invention is shown. The second raised border 95 provides for production of a card with a one-quarter of an inch (¼ in.) raised border layer. As such the second raised border 95 is the final layer for the other side of the present invention. This layer is of adequate thickness to allow guidance of the smaller paper panel into place with or without foam tape or dimensional foam stickers. The second raised border 95 is approximately six inches (6 in.) wide and four and one-half inches (4½ in.) tall and a thickness of one-eighth of an inch (⅛ in.). The second raised border 95 is generally “U”-shaped in appearance with three (3) second sides 100, each with a width of one-half inch (½ in.). The two (2) fifth side legs 105 are provided with a chamfer 60 about their interior corners.

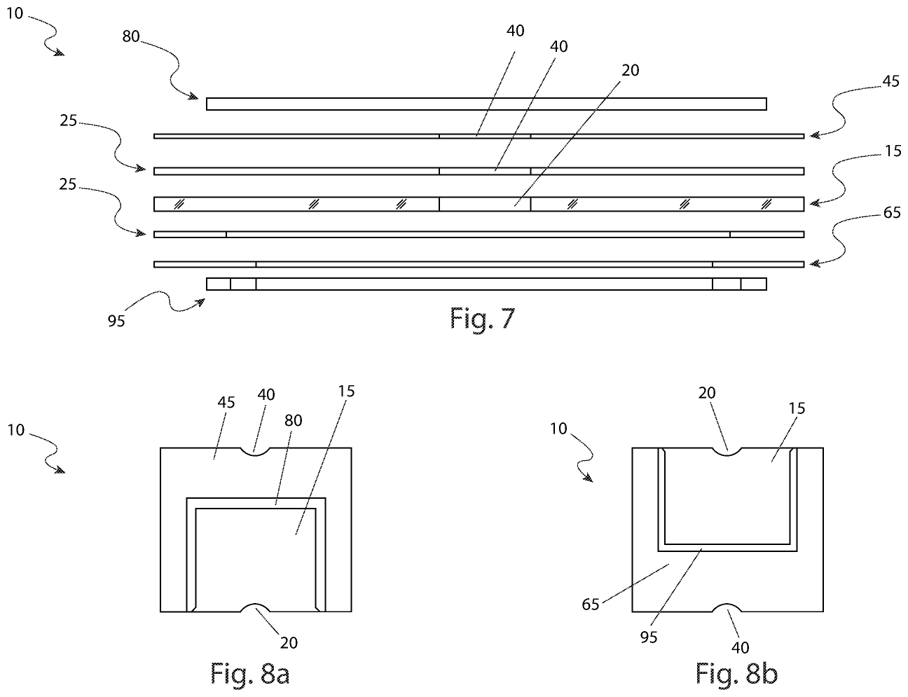

Referring next to FIG. 7, an exploded side view of the device 10, according to the preferred embodiment of the present invention is disclosed. The base 15 is centrally positioned as aforementioned described. Immediately above and below the base 15 are the two (2) A2 middle paper guides 25. The upper portion is then provided with a first inner exterior layer 45 and the lower portion is provided with a second inner exterior layer 65. Finally, the uppermost layer is comprised of the first raised border 80, while the lowermost layer is comprised of the second raised border 95. All of the above layers are centrally and symmetrically aligned. The first finger hole 20 is visible on the base 15 while the two (2) second finger holes 40 are visible on the A2 middle paper guide 25 and the first inner exterior layer 45. It is noted that the other two (2) second finger holes 40 are not visible in this view due to illustrative limitations.

Referring now to FIG. 8a, a top view of the device 10, according to the preferred embodiment of the present invention is depicted. This view exposes the base 15 along with its first finger holes 20. The first inner exterior layer 45 is also visible with the A2 middle paper guide 25 (as shown in FIG. 7) not visible due to illustrative limitations. Finally, the first raised border 80 is positioned on top. Note that the second finger holes 40 of both the first inner exterior layer 45 and the A2 middle paper guide 25 are visible on top.

Referring to FIG. 8b, a bottom view of the device 10, according to the preferred embodiment of the present invention is shown. This view exposes the base 15 along with its first finger holes 20. The second inner exterior layer 65 is also visible with the A2 middle paper guide 25 (as shown in FIG. 7) not visible due to illustrative limitations. Finally, the second raised border 95 is positioned on top. Note that the second finger holes 40 of both the second inner exterior layer 65 and the A2 middle paper guide 25 are visible on top.

### 2. OPERATION OF THE PREFERRED EMBODIMENT

The preferred embodiment of the present invention can be utilized by the common user in a simple and effortless manner with little or no training. It is envisioned that the device 10 would be constructed in general accordance with FIG. 1 through FIG. 8b. The user would procure the device 10 from conventional procurement channels such as craft supply retailers, discount stores, department stores, mail order and internet supply houses and the like.

During utilization of the device 10, the following procedure would be initiated: the user would decide on the side of layered border, either one-quarter or one-eighth inch (¼ in. or ⅛ in.) border and place the top or bottom of the device 10 face up, a four inch by five and one-quarter inch (4×5¼ in.) inch cardstock for one-eighth inch (⅛ in.) border side, or three and three-quarter inches by five inch (3¾×5 in.) cardstock for one quarter inch (¼ in.) border side would then be slid into the respective first rectangular opening 30. The card stock is then ready for upper layer placement of additional card layers. Upper layers may be built up from dimensional foam tape or stickers using adhesive glue if needed. Additional layers are placed on top using the first side edges 35, the second side legs 55, the third side legs 75, the fourth side legs 90, and the fifth side legs 105 as a guide. Once any adhesive has cured, the finished card may be removed by grasping along the first finger holes 20 and with the aid of the second finger holes 40, pull the finished card free, thus freeing the device 10 for continued use in a repeating manner. The device 10 may also be used to make edges for gift tags and smaller cards by the production of even more professional looking edges.

The following features of the present invention provide for the following benefits: a slim low-profile design, ideal for use by all ages and those who suffer from arthritis, bad eyesight, or other disability, may be used by children, passive design which requires no batteries of moving parts, can be easily transported, and ensures no more crooked corners. It is also environmentally friendly as it reduces mistakes and wasted material that would end up in landfills.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated.

What is claimed is:

1. An improved card making alignment device for ease and accuracy in creating cards from a card stock, the device comprising:
a base, the base having a center, a first side, a second side, a third side and a fourth side;
two first finger holes, a first of the first finger holes being configured on a center of the first side of the base, a second of the first finger holes being configured on a center of the third side of the base;
two A2 middle paper guides;
a first rectangular opening of a first of the A2 middle paper guides, the first rectangular opening being configured to be in a center of a lower center of the first side of the base thereby forming a first side edge;
a second rectangular opening of a first of the A2 middle paper guides, the second rectangular opening being configured to be in a center of a lower center of the third side of the base thereby forming a second side edge;
a first top mounted finger hole, the first top mounted finger hole being configured in an upper center of the first side;
a second top mounted finger hole, the second top mounted finger hole being configured in an upper center of the third side;
a first inner exterior layer, the first inner exterior layer being for guiding a card stock panel, the first inner being coupled to the first side of the base forming a first raised border and thereby forming a first second side leg;
a second inner exterior layer, the second inner exterior layer being for guiding a card stock panel, the second inner being coupled to the third side of the base forming a second second side leg; and
a first raised border and a second raised border, wherein the first raised border and the second raised border providing a guidance of the card stock.

2. The device according to claim 1, wherein the base providing a paper border guide for one-quarter inch card stock.

3. The device according to claim 1, wherein the base has a width of seven inches.

4. The device according to claim 1, wherein the base having a height of six inches.

5. The device according to claim 1, wherein the base having a thickness of one-eighth inch.

6. The device according to claim 1, wherein the first side having a length of seven inches.

7. The device according to claim 1, wherein the third side having a length of seven inches.

8. The device according to claim 1, wherein the first of the first finger hole having a diameter of one inch.

9. The device according to claim 1, wherein the second of the first finger holes having a diameter of one inch.

10. The device according to claim 1, wherein the first of the first finger holes has an exposure of one-quarter inch.

11. The device according to claim 1, wherein the first of the first finger holes has an exposure of one-quarter inch.

12. The device according to claim 1, wherein the base is made of a glass material.

13. The device according to claim 1, wherein the first raised border has a height of four and one-half inch.

14. The device according to claim 1, wherein the second raised border has a height of four and one-half inch.

15. The device according to claim 1, wherein the first raised border has a width of seven-eighths inch.

16. The device according to claim 1, wherein the second raised border has a width of seven-eighths inch.

17. The device according to claim 1, wherein the first second side leg has an interior corner with a chamfer.

18. The device according to claim 1, wherein the second second side leg has an interior corner with a chamfer.

19. The device according to claim 1, wherein the first exterior layer has a dimension of five and one-quarter inch by four and one-eighth inch.

20. The device according to claim 1, wherein the second exterior layer has a dimension of five and one-quarter inch by four and one-eighth inch.
